(19) United States
(12) Patent Application Publication
(10) Pub. No.: US 2003/0099757 A1
(43) Pub. Date: May 29, 2003

(54) Rice pudding method and composition

(76) Inventor: Donald Bruce Budinoff, Farmingdale, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/339,689

(22) Filed: Jan. 9, 2003

Related U.S. Application Data
(63) Continuation-in-part of application No. 10/035,756, filed on Dec. 31, 2001.
(60) Provisional application No. 60/301,522, filed on Jun. 28, 2001.

(51) Int. Cl. A23L 1/168

(52) U.S. Cl. 426/618

(57) ABSTRACT

A method and composition for aseptically processed rice pudding. The method for aseptically processing rice pudding, comprising either batch-wise or continuously cooking non-instant rice; partially dewatering the first mixture; forming a rice pudding by combining the dewatered first mixture and a pudding base, wherein an effective amount of starch remains in the rice pudding after partially dewatering the first mixture; and aseptically processing the rice pudding.

An aseptic rice pudding comprising: an aseptic mixture that includes from about 30.0 to about 40.0 percent by weight liquid milk, from about 9.0 to about 20.0 percent by weight sugar, and from about 25.0 to about 45.0 percent by weight of dewatered rice.

The present patent application is a continuation-in-part of a copending non-provisional U.S. patent application Ser. No. 10/035,756, filed Dec. 31, 2001 and entitled “Rice Pudding Method and Composition,” which is a non-provisional application of provisional application Ser. No. 60/301,522, filed Jun. 28, 2001.

### BACKGROUND OF THE INVENTION

1. Technical Field

The present invention relates generally to methods for aseptically processing rice products, compositions of rice products, and a composition of rice products. More specifically, the present invention relates to methods for aseptically processing rice pudding and aseptic compositions of rice puddings.

2. Related Art

During a conventional preparation of rice pudding starch is cooked out of rice grains by heating the rice grains in the presence of an assortment of ingredients such as milk products, egg, flavoring and coloring. This results in softening the rice for consumption, and also in creating a desirable texture and consistency because starch serves to thicken the pudding. Conventional processes require careful stirring of the rice pudding during the heating process to avoid scalding the pudding.

In U.S. Pat. No. 4,585,664, Kohlwey disclosed use of whole grains and broken grains of rice for preparation of a dry instant rice porridge mix. Kohlwey disclosed the rice may be instantized by employing a process similar to that disclosed by Hollis et al. in U.S. Pat. No. 2,828,209. The dry instant porridge mix may be added to milk, brought to a boil with stirring, removed from heat, and eaten after sanding for about five (5) minutes.

There is a need for an aseptic process for preparing rice pudding that increases the shelf life of the rice pudding.

### SUMMARY OF THE INVENTION

The present invention provides a method for processing rice pudding, comprising:

cooking a first mixture, wherein the first mixture includes non-instant rice and water;

partially dewatering the first mixture, wherein excess starch is removed from the partially dewatered first mixture;

forming a rice pudding that includes the partially dewatered first mixture and a pudding base, wherein the rice pudding has an effective amount of starch; and

aseptically processing the rice pudding.

A second embodiment of the present invention provides a method for processing rice pudding, comprising:

providing a continuous rice cooker;

providing a first mixture to the rice cooker, wherein the first mixture includes non-instant rice and heated water;

continuously cooking the first mixture in the cooker;

partially dewatering the first mixture after cooking;

forming a rice pudding by combining the dewatered first mixture and a pudding base, wherein an effective amount of starch remains in the rice pudding after partially dewatering the first mixture; and

aseptically processing the rice pudding.

A third embodiment of the present invention provides an aseptic rice pudding comprising:

an aseptic mixture that includes from about 30.0 to about 40.0 percent by weight milk, from about 9.0 to about 20.0 percent by weight sugar, and from about 25.0 to about 45.0 percent by weight of dewatered rice.

A fourth embodiment of the present invention provides a method for processing rice pudding, comprising:

continuously cooking a first mixture which includes non-instant rice and water;

combining the first mixture with a pudding base to form a rice pudding; and

aseptically processing the rice pudding.

A fifth embodiment of the present invention provides a method for processing rice pudding, comprising:

forming a first mixture, wherein the first mixture includes non-instant rice and heated water, wherein the heated water extracts starch from the rice, and wherein an effective amount of the extracted starch remains in the first mixture;

combining the first mixture and a pudding base to form a rice pudding: and

aseptically processing the rice pudding.

A sixth embodiment of the present invention provides a method for processing rice pudding, comprising:

forming a first mixture, wherein the first mixture includes non-instant rice and heated water, wherein the heated water extracts starch from the rice, and wherein an effective amount of the extracted starch remains in the first mixture;

combining the first mixture and a pudding base to form a rice pudding: and

aseptically processing the rice pudding.

A seventh embodiment of the present invention provides a method for processing rice pudding, comprising:

forming a first mixture, wherein the first mixture includes non-instant rice and heated water, wherein the heated water extracts starch from the rice, and wherein an effective amount of the extracted starch remains in the first mixture;

combining the first mixture and a pudding base to form a rice pudding:

cooling the rice pudding by adding the first mixture to the pudding base, wherein the pudding base is less than 50° F.; and

aseptically processing the rice pudding.

### BRIEF DESCRIPTION OF THE DRAWINGS

FIG. 1 depicts a method for aseptically preparing rice pudding, according to embodiments of the present invention;

FIG. 2 depicts a product tank for forming a blend of a portion of the rice pudding, according to embodiments of the present invention;

FIG. 3 depicts a product tank for forming a mixture of the blend and a rice, according to embodiments of the present invention.

FIG. 4 depicts a cross-sectional view of a hydration tube, equipped for aseptically processing a rice pudding, according to embodiments of the present invention;

FIG. 5 depicts a longitudinal cross-sectional view of the hydration tube of FIG. 4, equipped for aseptically processing the rice pudding;

FIG. 6 depicts a cross-sectional view of a holding tube, equipped for aseptically processing the rice pudding, according to embodiments of the present invention; and

FIG. 7 depicts a longitudinal cross-sectional view of the holding tube of FIG. 6, equipped for aseptically processing the rice pudding;

FIG. 8 depicts an apparatus for aseptically preparing rice pudding, wherein an effective amount of starch is retained in the cooked rice, according to embodiments of the present invention;

FIG. 9A depicts a method for batch-wise aseptically preparing rice pudding, wherein a non instant rice is cooked batch-wise, according to embodiments of the present invention;

FIG. 9B depicts a method for aseptically preparing rice pudding, wherein a non instant rice is cooked in a continuous cooker, according to embodiments of the present invention;

FIG. 10 depicts a continuous rice cooker, according to embodiments of the present invention; and

FIG. 11 depicts FIG. 8 after forming the rice pudding, according to embodiments of the present invention

### DETAILED DESCRIPTION OF THE EMBODIMENTS

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the embodiment. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

For the rice pudding of the present invention, it is important to know that the rice pudding may be processed aseptically but if it is not packaged aseptically it may not remain aseptic. The term “aseptic” is defined as substantially free from disease, fermentation or putrefaction. Hereinafter “aseptic method or aseptic process” or “process for preparing the rice pudding aseptically” or “processed aseptically” refer to a process or method for substantially freeing food from disease, fermentation or putrefaction.

An ultra-high-temperature (UHT) method for making rice pudding aseptically may include heating the rice pudding from about 270° F. to about 290° F. for holding times at least from about 15 to about 30 seconds. Hereinafter “ultra-high-temperature” (UHT) means subjecting the pudding to high temperature and short residence time to aseptically produce rice pudding, without making certain quality attributes unacceptable. The UHT aseptic process for preparing the rice pudding of the present invention may satisfy a 1999 United States Public Health Service/Food and Drug Administration Pasteurized Milk Ordinance (Pasteurized Milk Ordinance, Public Health Service/Food and Drug Administration Publication No. 229, 1999) governing preparation of pudding as long as the pudding is not held to be shelf-stable, that would require aseptic packaging of the aseptically processed rice pudding as well. The UHT aseptic process may provide extended shelf life of the rice pudding up to six weeks when the rice pudding of the present invention is packaged without aseptic packaging.

A purpose of the present invention is to make the rice pudding aseptic using the UHT aseptic process without causing the rice pudding to have unacceptable quality attributes. Hereinafter “acceptable quality attributes” refer to the rice pudding having acceptable texture, flavor, smoothness, color, sweetness, aftertaste, and “unacceptable quality attributes” refer to the rice pudding having unacceptable texture, flavor, smoothness, color, sweetness, aftertaste. Another important quality attribute may be that the rice becomes sufficiently hydrated by the high temperature and short time processing of the rice in the rice pudding that the rice may not be too hard to chew, yet not so soft after being subjected to high temperature and short time processing that the rice has lost piece integrity. Hereinafter, retaining a “piece integrity” means after being subjected to high temperature and short time processing that the rice may not be too hard to chew, or alternatively, be too soft so that it can be deformed by a human mouth without chewing. Food companies may utilize professional taste testers who have tasted acceptable and unacceptable rice pudding, wherein the taste testers may be able to distinguish whether the rice pudding has acceptable or unacceptable quality attributes. The rice in the rice pudding having acceptable quality piece integrity may lose this acceptable quality attribute if the rice becomes dry or brittle as the pudding ages.

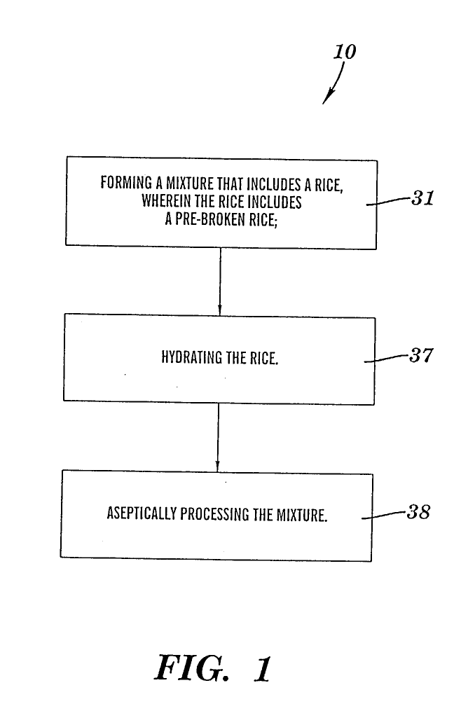

FIG. 1 depicts a method 10 for aseptically preparing a rice pudding, comprising the following steps: step 31, forming a mixture that includes a rice, wherein the rice includes a pre-broken rice; step 37, hydrating the rice; and step 38, aseptically processing the mixture.

Referring to FIG. 1, the rice of the step 37 of the method 10 may comprise a mixture of a whole grain and a pre-broken rice. In an embodiment, the rice may comprise from about 60 to about 80 percent by weight the broken rice and from about 20 to about 40 percent by weight the whole grain rice. Alternatively the rice may be a commercially available instant rice IM 75 comprising 75 percent by weight broken rice and 25 percent by weight whole grain rice.

Referring to FIG. 1, the mixture of the step 31 of the method 10 may further comprise milk from about 66.3 to about 77.6 percent by weight of the rice pudding and includes liquid milk, for example, 40% Butter Fat Cream, skim milk, and whole milk, and dry milk such as nonfat dry milk. Alternatively, a milk substitute such as sodium caseinate may be used.

Referring to FIG. 1, the mixture of the step 31 of the method 10 may further comprise a sugar from about 13.5 to about 17.1 percent by weight of the rice pudding and includes liquid sugar, sugared egg yolk, confectioners sugar and any alternative forms of sugar such as granular sugar. Alternatively, sugar substitutes such as saccharine or aspartamene may be used.

Referring to FIG. 1, the mixture of the step 31 of the method 10 may further comprise a starch from about 0.5 to about 1.0 percent by weight of the rice pudding and include rice starch. Alternatively, the starch of the step 31 of the method 10 may be purified starch from potato, cassava, tapioca, yucca, corn, wheat, modified starches such as pre-gelatinized, oxidized, acetylated, cationic or anionic starch. Purification of the starch may be done by extracting the starch using hot water or steam, then drying the starch to obtain purified starch.

Referring to FIG. 1, the mixture of the step 31 of the method 10 may further comprise a stabilizing agent from about 0.1 to about 0.3 percent by weight of the rice pudding and includes Kapa Carrageenan, a polysaccharide sea weed extract made up of repeating galactose units linked with alternating alpha 1-3, and beta 1-4 glycosidic linkages. In addition, the galactose units in this general structure often occur as 3,6-anhydro-D-galactose and sulfate esters may also be present on some galactose units. Kappa, iota and lambda types of carrageenan, know as kapa, iota and lambda are approved for use in food and may be used as stabilizing agents in the forming the mixture step 31 of the method 10. The primary differences which influence the properties of carrageenan are numbers and position of the ester sulfate groups on the repeating galactose units.

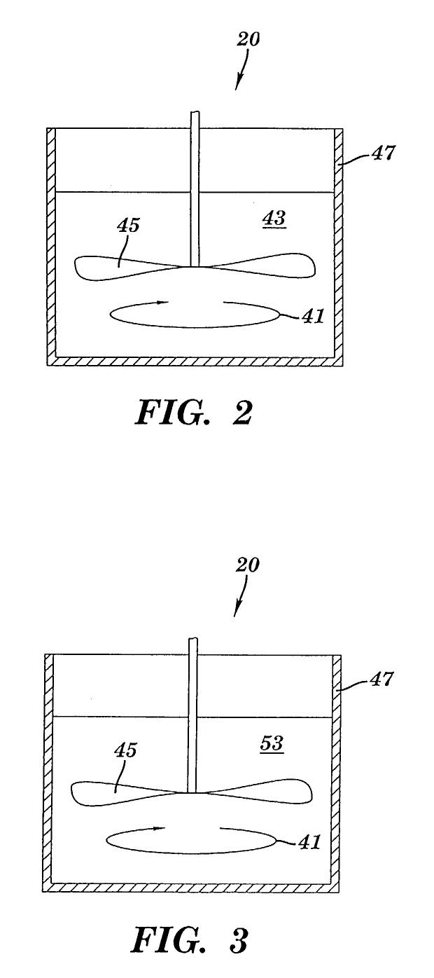

FIG. 2 depicts an apparatus 20 after forming the mixture 43 that includes the milk, the sugar; the starch; and the stabilizing agent according to the step 31 of the method 10. Referring to FIG. 2, the apparatus 20 may be a product tank 20 or any appropriate container 20 comprising a wall 47 and an agitator 45. Referring to FIG. 2, the blend 43 may have been formed by adding the milk, the sugar; the starch; and the stabilizing agent to the apparatus 20 according to the step 31 of the method 10, and rotating the agitator 45 in a direction of an arrow 41 for from about 5 to about 60 minutes.

Alternatively, referring to FIG. 2, the blend 43 may be homogenized at 1500 psi single stage. Hereinafter, the blend 43 may be homogenized single stage by passing the blend 43 at a flow rate from about 20 gallons per minute (gpm) to about 40 gpm under a pressure from about 1,000 to about 2,500 psi through a homogenizer valve.

Referring to FIGS. 1-2, in an embodiment of the present invention, in the step 31 of the method 10, the milk may be added to the apparatus 20, and warmed from about 40° F. to about 140° F., followed by addition of the sugar; the starch; and the stabilizing agent to the apparatus 20, and rotating the agitator 45 in a direction of an arrow 41 for from about 5 to about 60 minutes.

Referring to FIGS. 1-2, the blend 43 of the step 31 of the method 10 may further comprise a flavoring agent from about 0 to about 0.485 percent by weight of the rice pudding and include salt, wherein the salt includes sodium chloride, vanilla custard, tetra sodium pyrophosphate and egg enhancing flavor.

Referring to FIGS. 1-2, the blend 43 of the step 31 of the method 10 may further comprise a coloring agent that includes TiO₂ and may be from about 0 to about 0.1 percent by weight of the rice pudding.

FIG. 3 depicts FIG. 2 after forming a mixture 53 by adding the rice to the blend 43 in the apparatus 20 and rotating the agitator 45 in the direction of the arrow 41 for from about 5 to about 60 minutes, according to the step 31 of the method 10. Referring to FIG. 3, an ingredient feeder such as a silo, equipped with a feeder or other appropriate storage and feeding device may be used to add rice to the blend 43.

Referring to FIG. 3, in an embodiment in which the blend 43 may have undergone homogenization, such as for example single stage homogenization, the blend 43 may be cooled in the apparatus 20, equipped with the agitator 45 of the apparatus 20. Alternatively, the blend 43 may be cooled by circulating the blend 43 through a tubular and/or scraped surface heat exchanger. Alternatively, the blend 43 may be cooled by passing the blend 43 through a cooling tunnel. In an embodiment of the present invention, circulating the blend 43 through a tubular and/or scraped surface heat exchanger cooled the blend 43 from 45° F. to about 35° F.

Referring to FIG. 1, according to the step 37 of the method 10, numerous trial runs were conducted to effectively hydrate the rice so that it will have piece integrity after aseptic processing. Hereinafter, the high temperature and short time processing may “effectively hydrate” the rice in the rice pudding when the rice in the rice pudding that results from the aseptic processing of the rice pudding has piece integrity.

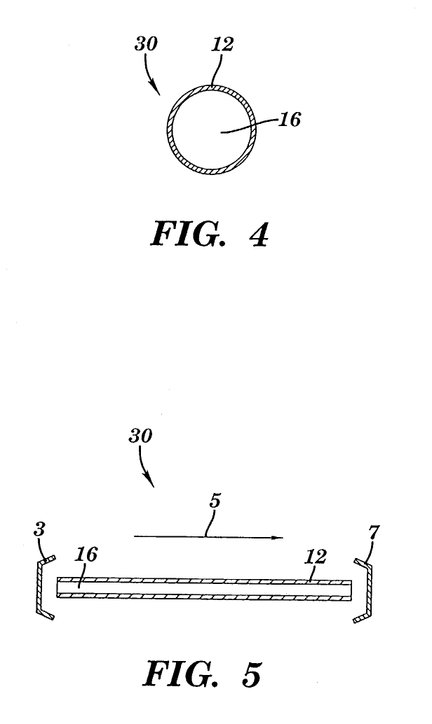

FIG. 4 depicts a cross-sectional view of an apparatus 30 for effectively hydrating the rice in the rice pudding, according to the step 37 of the method 10, as depicted in FIG. 1, and associated text supra. The apparatus 30 may be a hydration tube 30, comprising: an outer wall 12; and an open bore 16. The apparatus 30 may be equipped for heating from ambient to a temperature from about 170° F. to about 250° F. The apparatus 30 may be made from any of a variety of stainless steel materials or alternative materials capable of containing a rice pudding at a temperature range from about 170° F. to about 250° F. and at pressures from 0 to 1,500 psi without undergoing corrosion or rupture.

FIG. 5 depicts a longitudinal cross-section of the apparatus 30, wherein the mixture 53 of the homogenized blend 43 and the rice of the present invention is introduced into the apparatus 30, in a direction of an arrow 5. Referring to FIG. 5, the mixture 53 may be pre-heated using tubular and scrape surface heat exchanges from about 40° F. to about 250° F.

Referring to FIG. 5, a purpose of passing the mixture 53 of the homogenized blend 43 and the rice through the apparatus 30 may be to effectively hydrate the rice. Hereinafter, a “residence time” is a length of time the mixture 53, comprising: the rice; and the blend 43, remains in the apparatus 30 and may be heated from about 170° F. to about 250° F., resulting in the rice pudding having effectively hydrated rice. The residence time of the mixture 53 of the homogenized blend 43 and the rice in the apparatus 30 may be increased by increasing either a length or a diameter of the apparatus 30, without changing a flow rate of the mixture 53 through the apparatus 30. Alternatively the residence time of the mixture 53 of the homogenized blend 43 and the rice in the apparatus 30 may be decreased by decreasing the length or the diameter of the apparatus 30, without changing a flow rate of the mixture 53 through the apparatus 30. Another method of reducing the residence time in the apparatus 30 may be to increase a flow rate of the mixture 53 of the homogenized blend 43 and the rice through the apparatus 30, without changing the diameter and length of the apparatus 30. Alternatively, the residence time in the apparatus 30 may be increased by reducing the flow rate of the mixture 53 of the homogenized blend 43 and the rice in the apparatus 30, without changing the diameter and length of the apparatus Increasing the rate would reduce this critical residence time. Referring to FIG. 5, in order to achieve the residence time of from about 60 to about 360 seconds, one skilled in the art may determine the residence time of the rice pudding in the apparatus 30 by injecting a colored dye that may be detected by the human eye into the proximal end 3 of the apparatus 30 and measuring a difference in time between when the dye was injected to when it appeared at the distal end 7 of the apparatus 30. The difference in time (ΔT) is the residence time of the rice pudding for the flow rate of the rice pudding used during the determination of the residence time ΔT. Alternatively, moisture and temperature sensors could be placed in the mixture 53 to obtain a moisture and a thermal history of the mixture 53.

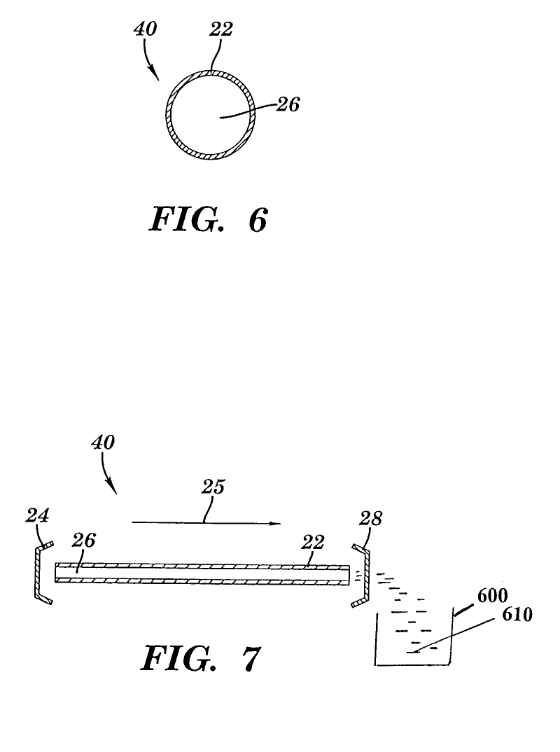

FIG. 6 depicts a cross-sectional view of the an apparatus 40, further comprising an outer wall 22 and an open bore 26, according to the step 38 of the method 10, as depicted in FIG. 1 and described in associated text supra. Referring to FIG. 6, the apparatus 40 may be a holding tube 40 and may be equipped for heating from ambient to a temperature from about 270° F. to about 290° F. Referring to FIG. 6, the apparatus 40 may be made from any of a variety of Stainless Steel materials or alternative materials capable of containing a rice pudding in a temperature range from about 270° F. to about 290° F. at pressures from 0 to 1500 psi without undergoing corrosion or rupture of the apparatus 40.

Referring to FIG. 1, in an embodiment of the present invention, according to the steps of the method 10, with the use of IM 75 Instant Rice mixture of whole rice and pre-broken rice, we determined that the added starch concentration could be reduced substantially from typical starch levels in aseptically (UHT ESL) processed pudding made from whole grain rice alone. Referring to FIG. 1, this is due to an added exposed surface area of the pre-broken rice in the IM 75 Instant Rice blend compared to the surface area of whole grain rice, which allows more starch to be extracted during the aseptic processing according to the steps of the method 10 because pre-broken rice has more surface area than whole grain rice.

FIG. 7 depicts a longitudinal cross-section of the apparatus 40, wherein the mixture 53, as depicted in FIG. 3, may be passed through the apparatus 40, in a direction of an arrow 25, according to the step 38 of the method 10, as depicted in FIG. 1 and described in associated text supra. Referring to FIGS. 4-7, in an embodiment of the present invention, the mixture 53 may be heated from about 250° F. to about 280° F. using tubular and/or scrape surface heat exchangers placed in line between the distal end 7 of the apparatus 20 and the proximal end 24 of the apparatus 40. The apparatus 40 is sized such that the rice pudding may have a residence time of from about 15 to about 30 seconds. The residence time of the mixture 53 in the apparatus 40 may be increased by increasing either a length or a diameter of the apparatus 40, without changing the flow rate of the mixture 53 through the apparatus 40. Alternatively the residence time of the mixture 53 in the apparatus 40 may be decreased by decreasing the length or the diameter of the apparatus 40, without changing the flow rate of the mixture 53 through the apparatus 40. Another method of reducing the residence time in the apparatus 40 may be to increase the flow rate of the mixture 53, without changing either a diameter or a length of the apparatus 40. Alternatively, the residence time in the apparatus 40 may be increased by reducing the flow rate of the mixture 53 in the apparatus 40, without changing either the diameter or the length of the apparatus 40.

Referring to FIG. 7, in order to achieve the residence time of from about 15 to about 30 seconds, one skilled in the art may determine the residence time of the rice pudding in the apparatus 40 by injecting a colored dye that may be detected by the human eye into the proximal end 24 of the apparatus 40 and measuring a difference in time between when the dye was injected to when it appeared at the distal end 28 of the apparatus 40. The difference in time (ΔT) is the residence time of the rice pudding for the flow rate of the rice pudding used during the determination of the residence time ΔT. Alternatively, moisture and temperature sensors could be placed in the mixture 53 to obtain a moisture and thermal history of the mixture 53.

Referring to FIGS. 4-7, the aseptically processed pudding 610 of the present invention may be cooled as it emerges from the distal end 28 of the apparatus 40. For example, the aseptically processed pudding 610 of the present invention may be cooled from about 280° F. to between about 50° F. and 60° F. by circulating it through a tubular and/or a scraped surface heat exchanger. The cooled aseptically processed pudding 610 may be collected in an aseptic surge tank 600 as it emerges from the tubular and/or a scraped surface heat exchanger. The aseptically processed pudding 610 of the present invention may be aseptically fed to a commercially available ultra-clean sterilized filler for filling final containers with the aseptically processed pudding 610. Hereinafter, “filling” refers to a process of transferring the aseptically processed pudding 610 of the present invention into final containers, using an aseptic ultra-clean sterilized filler. After filling, the aseptically processed pudding 610 may be further cooled from about 50° F. to about 40° F. using a cooling tunnel. Referring to FIGS. 1-7, the following example is provided to further describe an embodiment of the present invention, in particular, examples of methods for aseptically processing rice pudding and examples of the various rice pudding compositions described herein:

### EXAMPLE 1

### All % are Percent by Weight

Referring to FIG. 2 and the step 31 of the method 10 as depicted in FIG. 1, the blend 43 of a portion of the rice pudding was mixed in the product tank 20, equipped with the agitator 45, by adding the following to the product tank 20 and after completion of the addition, mixing for fifteen (15) minutes using the agitator 45 of the product tank 20:

Whole Milk 65.0-75.00%;

Liquid Sugar 13.00-17.00%;

40% Butter Fat Cream 1.00-2.00%;

Rice Starch 0.50-1.00%;

Sugared Egg Yolk 0.50-1.00%;

Non Fat Dry Milk 0.30-0.60%;

Carrageenan(Kappa) 0.10-0.30%;

Salt 0.1500%;

Vanilla Flavor 0.1500%;

Color 0.1000%;

Custard Flavor 0.0100%;

TetraSodiumPyrophosphate 0.01-0.10%; and

Egg Enhancing Flavor 0.0250%.

Referring to FIGS. 1-3, the blend 43 of the portion of the aseptically processed rice pudding in the product tank 20, was homogenized at 1500 psi single stage, and the homogenate was cooled to about 40° F. and collected in a product tank 20, equipped with an agitator 45. Referring to FIG. 3 and the step 31 of the method 10 as depicted in FIG. 1, Instant Rice IM 75 from about 7.00 to about 9.00% was added to the blend 43 in the product tank 20, with mixing using the agitator 45 to form mixture 53. The mixture 53 was pre-heated by circulating the mixture 53 through tubular and/or scrape surface heat exchangers from 40_F. to 250_F. Alternatively, the mixture 53 may be heated by the product tank 20 if the product tank 20 is equipped with a heated jacket.

Referring to FIGS. 4-7, according to the step 37 of the method 10 as depicted in FIG. 1, the mixture 53 is aseptically processed by introducing the pre-heated mixture 53 into the hydration tube 30, wherein the residence time of the mixture 53 in the hydration tube 30 is at least 90 seconds, and the temperature of the mixture 53 in the hydration tube 30 is from about 170° F. to about 250° F.

Referring to FIGS. 4-7, hold the mixture 53 in the hydration tube 30 for at least 90 seconds at the temperature from about 170° F. to about 250° F. Referring to FIGS. 4-7, according to the step 38 of the method 10 as depicted in FIG. 1, the rice pudding is aseptically processed by passing the mixture 53 through the holding tube 40, wherein the apparatus tube 22 is heated by a scrape and/or surface heat exchanger to about 280° F., wherein the residence time of the mixture 53 in the apparatus 40 is at least 25 seconds. Referring to FIGS. 4-7, according to the step 38 of the method 10 as depicted in FIG. 1, the mixture 53 is held at 280° F. for 25 seconds in the holding tube 40. Referring to FIG. 7, the aseptically processed pudding 610 of the present invention may be cooled from about 280° F. to between about 50° F. and 60° F. by circulating the aseptically processed pudding 610 through a tubular and/or scraped surface heat exchanger as it emerges from the distal end 28 of the tube 40. The cooled aseptically processed pudding 610 of the present invention may then be collected in an aseptic surge tank 600 as it emerges from the tubular and/or a scraped surface heat exchanger. The aseptically processed pudding of the present invention may be aseptically fed to a commercially available ultra-clean sterilized filler for filling final containers with the aseptically processed pudding 610. After filling, the aseptically processed pudding 610 may be further cooled from about 50° F. to about 40° F. using a cooling tunnel.

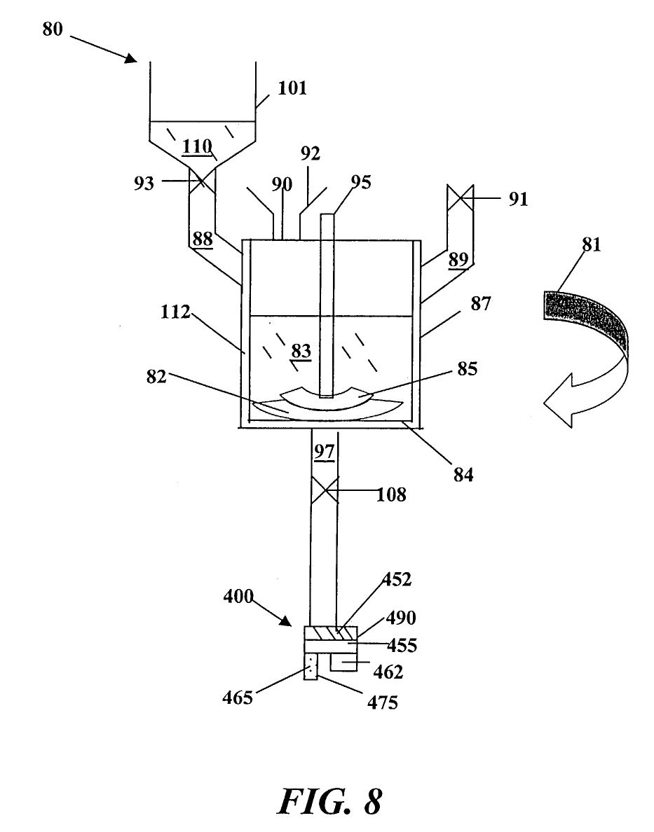

FIG. 8 depicts an apparatus 80 for cooking rice, that may comprise inter alia a vessel 87 and a solids feeder 90. The vessel 87 may be any appropriate container having a volume from about 100 to about 5,000 gallons (gal.) comprising: a jacket 112; an agitator 85; and a take-off valve 108. The jacket 112 may be heated by super heated steam under pressure, recirculating hot water, recirculating hot oil or an electric heater. The agitator 85 may be driven in a direction depicted by the arrow 81 and may further comprise a scrapper blade 82 for scrapping a bottom 84 of the vessel 87 to prevent solids from accumulating at the bottom 84 of the vessel 87. The apparatus 80 further comprises: a liquids feed line 89; a liquids control valve 91; a discharge line 97; a discharge control valve 108.

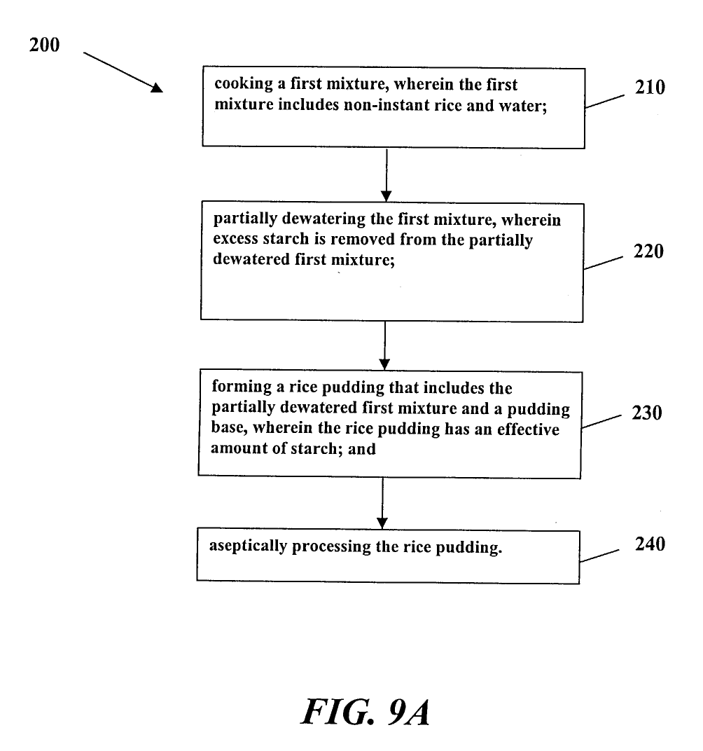

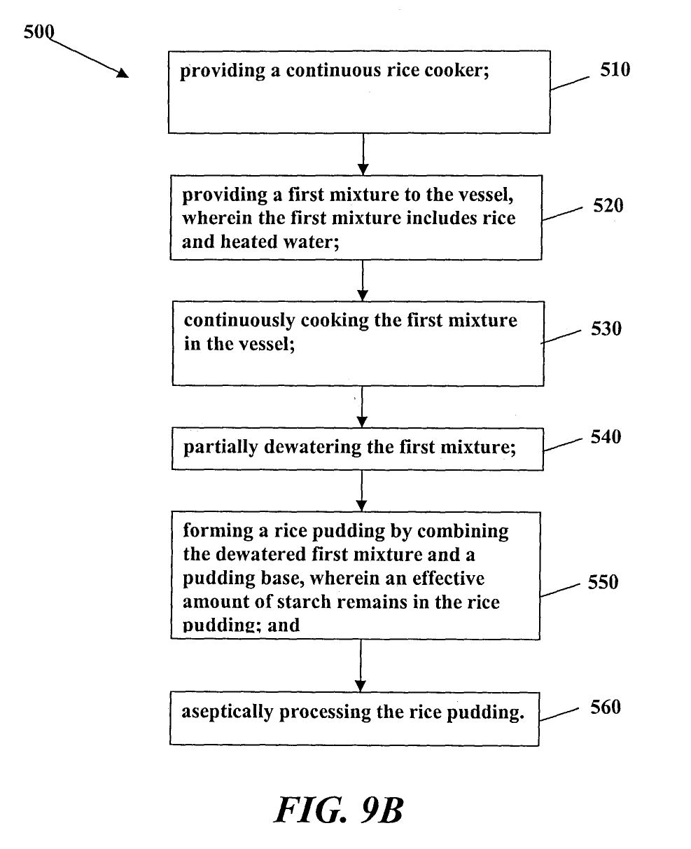

The non-instant rice 110 may be introduced into the vessel 87 from a solids feeder 90 through feed line 88 by opening a manually or automatically operated control valve 93, in accordance with the step 210 of the method 200, as depicted in FIG. 9A and described herein. Alternatively, the non-instant rice 110 may be added from bags or other container of the non-instant rice 110 into the vessel 87 by a person emptying a bag or container containing the non-instant rice 110 into a funnel 92 that may be operably coupled to an opening 94 into the vessel 87. The non-instant rice 110 may include milled rices such as long grain rice, medium grain rice, short grain rice, broken grain rice and combinations thereof. If the vessel 87 has a volume of 100 gal., it may cook from about 135 to about 165 pounds of the non-instant rice 110. Alternatively, the vessel 87 may have a volume of 1,000 gal., such that it may cook from about 1,350 to about 1,650 pounds of the non-instant rice 110. In another embodiment, the vessel 87 may have a volume of 5,000 gal., such that it may cook from about 6,750 to about 8,250 pounds of the non-instant rice 110. Generally, the range of the weight of non-instant rice 110 that may be cooked in the vessel 87 is 150 pounds +/−10% per 100 gal. of volume of the vessel 87. After adding the non-instant rice 110 to the vessel 87, hot water may be added to the vessel 87 through fluid feed line 89, wherein liquid feed control valve 93 may regulate the hot water feed rate, resulting in forming a first mixture 83. The hot water is pumped or gravity fed from a heat exchanger capable of heating water from about 170° F. to about 212° F., preferably from about 190° F. to about 212° F. through fluid feed line 89. An amount of hot water may range from about 300 pounds (30 gal.) to about 550 pounds (55 gal.) may be added to the non-instant rice 110 to form the mixture 83 in the 100 gal. vessel 87, in accordance with the step 210 of the method 200. The mixture 83 may be cooked at a temperature from about 170° F. to about 212° F. for from about 10 min. to about 50 min., preferably the mixture 83 may be cooked at a temperature from about 190° F. to about 212° F. for from about 20 min. to about 35 min. Hereinafter, “cook”, “cooking” or “cooked” means exposing the non-instant rice 110 to heated water such that the water hydrates the rice 110, causing it to soften and starch to be extracted from it. It has been found that exposing non instant rice 110 to water at ambient temperature for any time less than 45 min., preferably from about 15 min to about 45 min. also begins the hydration process such that an incidence of rice kernal or outer shell splitting is reduced when the non instant rice 110 is later cooked. Such splitting is termed X-ing and is described herein. Alternatively, exposing the non instant rice 110 to water at ambient temperature for longer than 45 minutes may reduce the incidence of X-ing when the non instant rice 110 is later cooked. The minimum and maximum values of the range of the amounts of hot water that may be added to the non-instant rice 110 to form the first mixture 83 in the 100 gal. vessel 87 may be increased by a factor of ten (10) for the 1,000 gal. vessel 87 and by a factor of 50 for the 5,000 gal. vessel 87. Alternatively a ratio of the parts of rice 110 by weight to the parts of water by weight in the first mixture 83 may be less than or equal to 0.5, wherein the total weight of the non-instant rice 110 may be from about 135 to about 165 lbs in the 100 gal. vessel 87. The minimum and maximum values of the range of the weight of the non-instant rice 110, when the ratio of non-instant rice 110 to water is less than or equal to 0.5 may be increased by a factor of ten (10) in the 1,000 gal. vessel 87 and by a factor of 50 in the 5,000 gal. vessel 87.

FIG. 8 depicts the apparatus 80 may further comprise a de-watering conveyor 400 for removing excess cook water 465 and starch that may be extracted during the cooking of the non-instant rice 110 in the hot water. Hereinafter, “excess cook water” is an amount of water used for cooking rice that exceeds the amount of water needed to substantially completely hydrate the rice. It has been found that substantially complete hydration of milled rice requires about two (2) parts by weight of water to one (1) part of the non-instant rice 110. The non-instant rice 110 may be cooked with excess cook water 465 because a rice water slurry is easier to move through pipes by gravity feed or by pumping and because discarding the excess cook water 465 as waste, through an excess water discharge port 475, is a means to reduce a starch level in the first mixture 83. The de-watering conveyor 400 comprises a water permeable belt 455 that allows excess cook water 465 in the first mixture 83 to pass through the water permeable belt 455, leaving a partially de-watered first mixture 452 on the belt 455, in accordance with the step 220 of the method 200, as depicted in FIG. 9A and described herein. The water permeable belt 455 may be made from water permeable materials such as a fine mesh wire, cloth or plastic screen, cloth gauze, webbed plastic matting or other appropriate water permeable material that is permeable to water, but not to the partially de-watered first mixture 452 on the belt 455. The de-watering conveyor 400 comprises: the excess water discharge port 475, wherein the excess cook water 465 may be discharged to waste; and a de-watered rice discharge port 490 for discharging de-watered first mixture 452, for example, the cooked rice from the first mixture 83.

FIG. 9A depicts a method 200 for processing rice pudding, that comprises steps 210-240. Referring to FIG. 8, step 210 of the method 200 comprises: cooking a first mixture 83, wherein the first mixture 83 includes non-instant rice 110 and water. The non-instant rice 110 of the first mixture 83 may be provided in accordance with the step 210 of the method 200, for example, from the solids feeder 101 depicted in FIG. 8, and described in associated text herein. A rate of addition of the non-instant rice 110 from solids feeder 101 may be increased by opening a manually or remote operated control valve 93. The rate may be based on gravity feed or an area above the non-instant rice 110 in the feeder 101 may be pressurized with gas such as nitrogen or air to increase the rate of addition of the non-instant rice 110 to the vessel 87. Alternatively, the heated water and the non-instant rice 110 may be added concurrently, or the heated water may be added before the non-instant rice 110 is added to the vessel 87 to form the first mixture 83. The water may be preheated in a temperature range from about 170° F. to about 212° F. or more preferably from about 190° F. to about 212° F. prior to adding it to the vessel 87. Cooking the non instant rice is accomplished by maintaining the temperature of the first mixture 83 in the vessel 87 in the range from about 170° F. to about 212° F. for from about 10 min. to about 50 min. or more preferably from about 190° F. to about 212° F. for from about 20 min. to about 35 min., by re-circulating hot water, steam under pressure or hot oil in the jacket 112.

A purpose of step 210 is to cook the first mixture 83, wherein the non-instant rice 110 becomes hydrated and starch is extracted into the hot water, resulting in a softening of the rice kernal. Typically, a ratio of 0.5 parts by weight of rice 110 to water provides sufficient water to completely hydrate the rice, resulting in a softened rice kernal having piece integrity and preservation of other aforementioned quality attributes. Hereinafter, the “rice kernal” is a seed of the rice. Hereinafter, “cook rice,” “cooking rice” or “cooked rice,” means maintaining the first mixture 83 in hot water having a temperature from about 170° F. to about 212° F., resulting in softening the non instant rice 110, while preserving its piece integrity, enabling the cooked rice to maintain its piece integrity quality attribute. A test to determine whether the rice has maintained its piece integrity after cooking the rice is a “mouth feel” test. The “mouth feel” test is a use test performed by a professional expert in the rice pudding industry. In performing the “mouth feel” test, the expert determines whether the cooked rice has adequate piece integrity based on crushing it with a utensil such as a spatula, squeezing it with the hands, or tasting it. Too much cooking such as heating the rice 110 for longer than 50 minutes in a temperature range from about 170° F. to about 212° F. results in rice 110 that is too soft. For example, cooking, such as heating the rice 110 for longer than 50 minutes in a temperature range from about 170° F. to about 212° F. results about 10% of rice 110 being broken during mixing and pumping. Too little cooking leads to rice 110 being too crunchy. This was determined by washing the cooked rice out of the rice pudding 610, as depicted in FIG. 7 and described herein, after completing the steps of the method 200 for aseptically processing the rice pudding and ascertaining the percentage of broken kernals of rice. Overcooking rice leads to broken rice. Undercooked rice is more susceptible to spoilage in the steps 210-230 preceding the aseptic processing step 240 of the method 200 because shorter cook time allows more bacteria to survive. In one embodiment, cooking the first mixture 83 in the vessel 87 in the range from about 170° F. to about 212° F. for about 10 to about 50 minutes, more preferably from about 190° F. to about 212° F., for about 20 min. to about 35 min., produced the first mixture 83 that includes cooked non-instant rice 110 having acceptable mouth feel based on the aforementioned mouth feel use test.

FIG. 8 depicts an apparatus 400 for partially dewatering the first mixture 83, wherein excess starch is removed from the partially dewatered first mixture 452, in accordance with the step 220 of the method 200. In the step 220, a ratio of parts by weight of the non-instant rice 110 to parts by weight of water in the first mixture 83 is less than or equal to 0.5, wherein excess cook water 465 extracts starch from the rice, and wherein the excess cook water 465 removes excess starch during dewatering of the mixture 83.

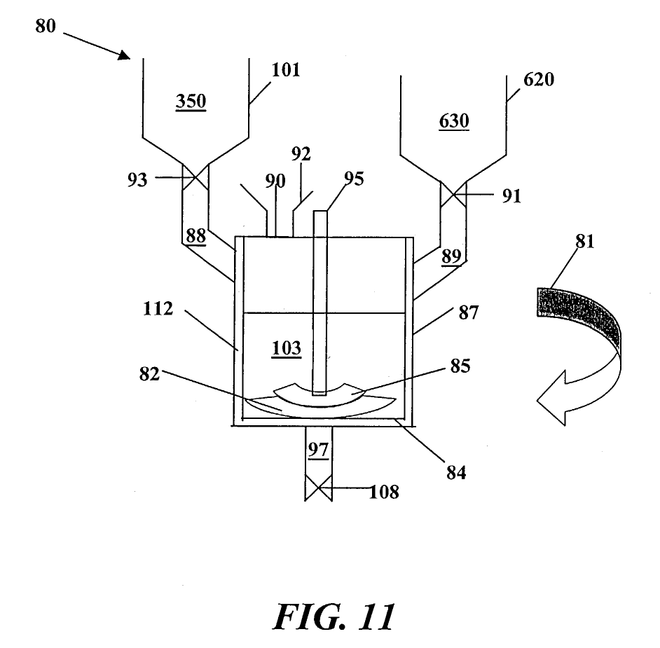

FIG. 11 depicts an apparatus 80 for forming a rice pudding 103 that includes the partially dewatered first mixture 452 and a pudding base 630, wherein the rice pudding 103 has an effective amount of starch, in accordance with the step 230 of the method 200. Hereinafter, “an effective amount of starch” is the minimum amount or concentration or level of starch in the rice pudding 103 or the aseptically processed rice pudding 610, as depicted in FIG. 8 and FIG. 7 respectively, such that the rice pudding 103 or 610 satisfy minimum texture, taste and stability quality attributes as determined by professional experts in the rice pudding industry. The pudding base 630 may comprise, for example, liquid milk, sugar, cream, non-fat dry milk, egg yolk, such as sugared egg yolk, phosphate, such as tetra sodium pyrophosphate, flavoring agent, coloring agent and combinations thereof. Referring to FIGS. 8-9A, a sufficient amount of the starch that was extracted into the first mixture 83 from the non-instant rice 110 during cooking is retained in the partially dewatered first mixture 452, in accordance with the step 220 of the method 200, such that the rice pudding 103, formed in step 230, has an effective amount of starch. Starch in the rice pudding 103 contributes to the flavor quality attribute of the pudding. It has been found that there is no need to add starch to the rice pudding 103 of the present invention in order to achieve acceptable flavor quality attributes because the rice pudding 103 has an effective amount of starch. Further, starch stabilizes the rice pudding. Hereinafter “stabilizer” or “stabilizes” or “stabilizing” refers to starch, Kapa Carrageenan, agar or other like ingredients that impart reduced flow properties to a pudding characteristic of a gel as compared to the liquid ingredients in the rice pudding 103. If all the water used to cook the non-instant rice 110 remains with the mixture 83, as is the case when the ratio of parts by weight of rice 110 to parts by weight of water is 0.5, all the extracted starch from the non-instant rice 110 will also remain with the rice 110 because the extracted starch is in the mixture 83. It may be necessary to remove excess starch from the first mixture 83 made from medium and short grain non-instant rice 110 in order to achieve the effective amount of starch in the rice pudding 103 needed to satisfy the minimum texture, taste and stability quality attributes as determined by professional experts in the rice pudding industry, and to avoid causing the rice pudding to become thixotropic, since the medium and short grain rice contains more starch as amylopectin than long grain rice. Alternatively, it may not be necessary to remove starch from the first mixture 83 if the first mixture 83 includes long grain non-instant rice 110, if the rice pudding 103 has the effective amount of starch needed to satisfy the minimum texture, taste and stability quality attributes as determined by professional experts in the rice pudding industry, and to avoid causing the rice pudding to be thixotropic. Hereinafter, “thixotropic” or “thixotropy” means a property exhibited by certain materials of becoming fluid when stirred or shaken and returning to the semisolid state upon standing. It may be desirable to remove some of the starch, in order that the rice pudding 103 made from the non-instant rice 110 may not become too thixotropic during shelf aging. If the rice 110 is cooked with more water than is necessary to completely hydrate the rice 110, such as, for example, if a ratio of parts by weight of rice 110 to parts by weight of water in the first mixture 83 is less than 0.5, the water containing excess starch may be mechanically separated from the first mixture 83. The excess starch may be mechanically separated from the first mixture 83 by placing the first mixture 83 on the de-watering belt 455 comprising, for example, a fine mesh wire, cloth or plastic screen, such that water, but not the cooked first mixture 83, may drain through the fine mesh screen by gravity feed, resulting in separation of excess cook water 465, wherein the water is excess because it is not needed for hydration of the rice. This results in excess starch being removed from the mixture 83, such that there is sufficient starch for flavoring and stabilizing the rice pudding 103, but not causing undesirable thixotropic shelf-age instability. For example, a non-thixotropic, rice pudding 103 may be prepared from non-instant rice 110 that has been cooked using a ratio of parts by weight of rice 110 to parts by weight of water in the first mixture 83 of 0.37, wherein 13% by weight of the cook water and the dissolved starch therein is discarded. When a batch of rice is used that provides excess starch, the excess starch may be discarded with the excess cook water 465 by providing more cook water 465 than is needed to completely hydrate the rice during cooking in step 210 of the method 200, by adjusting the parts by weight of rice to the parts by weight of water to a ratio less than 0.5, as depicted in FIGS. 8 and 9 and described herein. Aseptically processed rice pudding 610 as depicted in FIG. 7 and describe supra, in accordance with the step 560 of the method 500, that include this embodiment, have been found to not become thixotropic on standing for up to six weeks after packaging. The inventor believes the aseptically processed pudding 610 of the present invention may exhibit greater shelf stability, i.e. not become thixotropic, because the aseptically processed pudding 610 has the effective amount of starch.

A purpose of the agitator 85 having the scrapper blade 82 for scraping the bottom 84 of the vessel 87 is to mix the ingredients in the first mixture 83 during the step 210 so that solids such as for example, the non-instant rice 110, are evenly distributed throughout the first mixture 83. A second purpose of the agitator 85 having the scrapper blade 82 for scraping the bottom 84 of the vessel 87 is to break-up agglomerates of rice pieces in the first mixture 83 that may form because the extracted starch, i.e., extracted by the hot water in the step 210 of the method 200, coats the rice pieces, resulting in the rices of the first mixture 83 sticking or adhering together. Further, rice agglomerates are more problematic when the non-instant rice 110 includes the medium and short grain rice because it contains more starch as amylopectin than long grain rice, resulting in the mixture 83 forming rice agglomerates. The agglomerates may be reduced in size by increasing the agitation or may require a ratio of rice 110 to water less than 0.5. Reducing the size of the agglomerates is necessary for the resulting rice pudding 103 to achieve acceptable quality attributes regarding texture and smoothness. The agitator 85 and blade 82 may be any appropriate low shear stirring device such as an agitator of a dough mixer, such that the shear produced may be sufficient to break-up the agglomerates without causing the rice in the first mixture 83 to lose piece integrity, i.e., not damage the rice in the first mixture 83 such as cause the shape of the rice to become distorted, mashed, or broken. Adequate “piece integrity” means after being subjected to shear by the agitator 85 and blade 82 during processing, the shape of the rice may not be distorted, mashed, or broken, such that a professional expert in the rice pudding industry may detect a mashed, broken or distorted grain of rice. Hereinafter, “damage the rice,” “damaged rice,” or “damaging the rice” means rice whose shape has been distorted, mashed or broken due to processing or pumping the first mixture 83, such that the cooked, hydrated rice cooked in, for example, step 210 of the method 200 does not have acceptable mouth feel when evaluated by the “mouth feel” test described herein.

FIGS. 6-7 depict an apparatus 40 for aseptically processing the rice pudding 103, in accordance with step 240 of the method 200, as depicted in FIG. 9A and described in associated text infra.

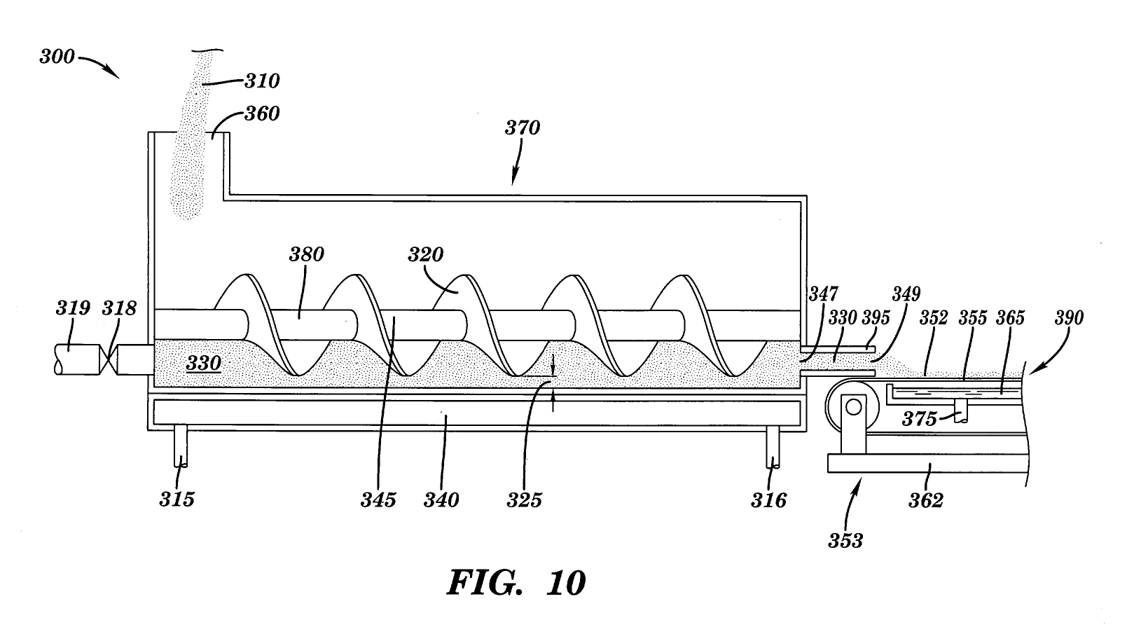

FIG. 10 depicts an apparatus 300 comprising a continuous rice cooker 370 and a continuous dewatering conveyor 353 for continuously dewatering the cooked non-instant rice 330 of the present invention. The continuous rice cooker 370 comprises; a helical auger 320 operably coupled to a motor driven rotating shaft 380; a vessel heating jacket 340; and heat lines 315 and 316 for providing re-circulating hot water, steam under pressure or hot oil in the jacket 340, wherein the steam or oil may maintain a temperature in the continuous rice cooker 370 from about 170° F. to about 212° F., more preferably from about 190° F. to about 212° F. Alternatively, the jacket 340 may be electrically heated. The rotating shaft 380 rotates the helical auger 320 clockwise when viewing the output port 390 along a longitudinal axis of the rotating shaft 380 and the helical auger 320.

The continuous rice cooker 370 comprises: a hot water feed line 319 and a control valve 318, for providing and regulating a feed of hot water into the continuous cooker 370, such that the hot water reaches a constant level 345 in the continuous cooker 370; an addition port 360 for introducing a non-instant rice 310; a discharge port 347 of the continuous cooker 370; a transfer line 395; and a discharge port 349 of the transfer line 395, wherein the first mixture 330 from the discharge port 349 may be transferred to a de-watering conveyor 353.

The continuous de-watering conveyor 353 comprises: a water permeable belt 355 that allows excess cook water 365 from the first mixture 330 to pass through the water permeable belt 355. The water permeable belt 355 may be made from water permeable materials such as a fine mesh wire screen, cloth gauze, webbed plastic matting or other appropriate water permeable material that is permeable to water, but not to the partially de-watered first mixture 352 on the belt 355. The continuous de-watering conveyor 353 comprises: a water discharge port 375, wherein the excess cook water 365 may be discharged to waste; and a partially de-watered first mixture 352 operably coupled to a pump or other appropriate means for providing partially de-watered first mixture 352.

FIG. 9B depicts a method 500 for processing a rice pudding, comprising steps 510-560. Referring to FIG. 10, a continuous cooker 370 is provided, wherein the continuous cooker 370 includes a helical auger 320 that rotates in a clockwise direction when viewed along the longitudinal axis of the continuous cooker 370, in accordance with the step 510 of the method 500. A first mixture 330 is provided to the continuous cooker 370, wherein the first mixture 330 includes the non-instant rice 310 and heated water, in accordance with the step 520 of the method 500. The first mixture 330 may be provided in the continuous cooker 370 by adding the non-instant rice 310 into addition port 360, wherein the heated water having a temperature from about 170° F. to about 212° F., more preferably from about 190° F. to about 212° F. has been provided to the continuous cooker 370 through line 319, in accordance with the step 510 of the method 500. Alternatively, in one embodiment, before the non-instant rice 310 is provided to the continuous cooker 370, the non-instant rice 310 may be exposed to water at ambient temperature for any time less than 60 minutes, preferably for about 15 min. to about 45 min. For example, the non-instant rice 310 may be added from a solids feeder 101 of the apparatus 80 such as depicted in FIG. 8 and described in associated text herein. A purpose of exposing the non-instant rice 310 to water at ambient temperature may be to provide the mixture 310 to the continuous cooker 370 as a slurry such that may the mixture 310 may be moved by the auger 320 toward the discharge port 349 without damaging the rice such as distorting the shape, breaking or mashing the non-instant rice 310 in the first mixture 330 during displacement by the helical auger 320. In one embodiment it has been found that exposing the non-instant rice mixture 310 to water at ambient temperature for from about 15 minutes to about 45 minutes results in a lower incidence of the rice kernals of the non-instant rice 310 splitting open, in a process termed X-ing (see discussion infra). Aseptically processed rice pudding 610 as depicted in FIG. 7 and describe supra, in accordance with the step 560 of the method 500, that include this embodiment, have been found to not become thixotropic on standing for up to six weeks after packaging. The inventor believes the aseptically processed pudding 610 of the present invention may exhibit greater shelf stability, i.e. not become thixotropic, because X-ing may increase a liklihood of small fragments of rice to break off the rice kernal. The presence of the small fragments may cause the aseptically processed pudding 610 to become thixotropic in less than six weeks after packaging, much like fumed silica causes ketchup to become thixotropic on standing after packaging. The non-instant rice 310 may be selected from the group of milled rices consisting of long grain rice, medium grain rice, short grain rice, broken grain rice and combinations thereof. The non-instant rice 310 may be added from bags, or alternatively, from a solids feeder containing the non-instant rice 310, wherein the solids feeder of the apparatus 300 may be operatively coupled to the addition port 360, such as may be the solids feeder 101 to the feed line 89 of the apparatus 80 as depicted in FIG. 8 and described herein.

Referring to FIG. 10, the heated water is provided to the first mixture 330 in the continuous cooker 370 in accordance with the step 510 of the method 500, through heated water feed line 319. Heated water having a temperature in a range from about 170° F. to about 212° F., more preferably from about 190° F. to about 212° F. is provided to the continuous cooker 370 from, for example, a heat exchanger through the hot water feed line 319 and regulated by the control valve 318, such that the hot water reaches a constant level 345 in the continuous cooker 370. In one embodiment, the water has a temperature in the range of about 205° F. to about 212° F. Alternatively, food quality steam may be used to maintain the temperature of the vessel in the range of about 205° F. to about 212° F., wherein the steam has been filtered to remove inorganic contaminants containing, for example, iron, sulfur, and organic contaminants such as organic volatiles from burning fuel oil, coal, or gas to generate steam from steam generators such as oil, coal or gas burning boilers.

The first mixture 330 is continuously cooked in the continuous cooker 370 having a helical auger 320 such as a Continutherm available from Blentech (Rohnert Park, Calif. 94927), wherein the cooked first mixture 330 is discharged by rotating the helical auger 320, in accordance with the step 530 of the method 500. Hereinafter, “discharged” means moving the cooking first mixture 330 in a direction of an arrow 317 by the rotating shaft 380 and the helical auger 320 toward the discharge port 349, in accordance with the step 530 of the method 500. The auger 320 is not meant to do any shear. The first mixture 330 may be displaced in a direction of an arrow 317 by the rotating shaft 380 and the helical auger 320 toward the discharge port 349, in accordance with the step 530 of the method 500. The heated water included in the first mixture 330 is also moved by the auger 320 toward the discharge port 349 to avoid damaging the rice such as distorting the shape, breaking or mashing the non-instant rice 310 in the first mixture 330 during displacement by the helical auger 320. The control valve 318 may be opened or closed such that the heated water that is included in the first mixture 330 that is discharged from the continuous cooker 370 through discharge port 349 is replenished in the continuous cooker 370 such that the heated water level 345 in the continuous cooker 370 is maintained.

Many experiments were performed to optimize a residence time or cook time and a temperature range for continuously cooking the first mixture 330 in the apparatus 300, in accordance with the step 530 of the method 500. In one embodiment, feeding from about 300 to about 360 pounds per hour of the non-instant rice 310 to the apparatus 300, wherein an internal volume of the continuous cooker 370 includes a range of about 120 to about 1,280 cubic feet, wherein a diameter of the auger 320 includes a range of about 2 to about 4 feet and a length in a range of about 15 to about 40 feet, and wherein the auger 320 rotated from about 0.2 to about 0.6 revolutions per minutes (rpm), produced from about 900 to about 1100 pounds per hour of partially de-watered first mixture 352. In one embodiment, processing the rice above 208° F. for a residence time greater than 27 minutes, in accordance with the step 530 of the method 500, results in X-ing the rice kernal. This was determined by washing the cooked rice out of pudding after completing the steps of the method 500 for processing rice pudding and inspecting the cooked rice under a 10-fold magnifying glass. The isolated rice showed X-ing, wherein the rice kernal had split open, such that “X” shaped slits had opened lengthwise along the rice kernal. Under cooked rice also is more susceptible to spoilage in the steps preceding the aseptic processing step 560 of the method 500 because shorter residence time allows more bacteria to survive. In one embodiment, cooking the non-instant rice 310 in the range from about 170° F. to about 212° F. for from about 10 min. to about 50 min., more preferably from about 190° F. to about 212° F. for from about 20 min. to about 35 min. or most preferably from about 205° F. to about 208° F. for a residence time from about 25 to about 28 minutes, in accordance with the step 530 of the method 500, resulted in a partially dewatered first mixture 352, in which the rice pudding 103 made from the dewatered first mixture 352 had acceptable mouth feel based on the aforementioned mouth feel use test. In one embodiment, cooking the non-instant rice 310 at a temperature of 208° F. for a residence time of 28 minutes, in accordance with the step 530 of the method 500, resulted in a partially dewatered first mixture 352, in which the rice pudding 103 made from the dewatered first mixture 352 had acceptable mouth feel based on the aforementioned mouth feel use test.

The residence time may be measured as a time in minutes for the auger 320, rotating as described herein, to move a marker such as a float that may have been included with the non-instant rice 310 to the discharge port 347. It was found that rotating the auger 320 one (1) revolution in 2.45 minutes produced a residence time of 28 minutes, i.e., rotating the auger 320 one revolution in 2.45 minutes moved a marker such as a float in the first mixture 330 through the continuous cooker 370, such that the float was discharged from the discharge port 347 in a time substantially equal to 28 minutes.

Another purpose of the method 500 is to retain an effective amount of the starch in the rice pudding of the present invention to achieve the aforementioned flavor quality attribute, in accordance with the continuous cooking step 530 of the method 500. Starch also stabilizes the rice pudding by thickening it or binding it so that it will remain on an eating utensil such as a spoon and also achieve the desired texture quality attribute. Hereinafter, an ingredient in rice pudding that “stabilizes,” “is stabilizing,” or “is a stabilizer” is an ingredient in the rice pudding that includes any ingredient such that adding it to the rice pudding results in imparting reduced flow properties to the pudding characteristic of a gel as compared to the liquid ingredients of the rice pudding. The effective amount of starch in the rice pudding of the present invention may be achieved by partially dewatering the cooked first mixture 330, such that excess starch that is dissolved in the water may be removed from the cooked first mixture 330 during the dewatering process, in accordance with the step 540 of the method 500. Hereinafter, “excess starch” is that amount of starch that may be in the partially dewatered first mixture 352 results in the rice pudding 103 made by the method 500 having greater than the effective amount of starch needed to act as a stabilizer and to achieve the aforementioned flavor quality attribute.

As mentioned above, excess starch may cause rice pudding to become thixotropic during shelf aging. Referring to FIG. 10, it may be desirable to remove the excess starch by providing excess cook water 365 in the step 530 of the method 500, followed by partially dewatering, as in Step 540 of the method 500. Hereinafter, “excess cook water” is when a ratio of parts by weight of non-instant rice 310 to parts by weight of water in the first mixture 330 is less than 0.5. If the first mixture 330 is cooked with more water than is necessary to completely hydrate the rice 310, such as, for example, if a ratio of water in the first mixture 330 is less than 0.5 parts by weight of rice 310 to parts by weight of water, the cooked first mixture 330 may be dewatered in the step 340 of the method 500 to remove excess starch in the cooked partially dewatered first mixture 352. It was found that hydration of the non-instant rice 310 in the continuous cooking step 530 of the method 500, requires one (1) part by weight of water to two (2) parts by weight of the non-instant rice 310. Thus, a ratio substantially equal to 0.5 parts by weight of rice to parts by weight of water is necessary for hydration of the non-instant rice 310 to occur in the continuously cooking the first mixture 330 step 530 of the method 500. The correct amount of excess cook water 365 needed to achieve the effective amount of starch in the rice pudding of the present invention may be determined by one skilled in the art by conducting experiments in which the parts by weight of the non-instant rice 310 to parts by weight of water ratio is varied from 0.1 to 0.5. It was found that if no excess cook water 365 were used in the continuous cooking step 330 of the method 500, and thus, all the starch that is extracted from the non-instant rice 310 by the continuous cooking step 530 of the method 500 is retained in the rice pudding, the pudding may become undesirably thixotropic during shelf aging.

Therefore, it may be necessary to provide lower ratios of rice to water than 0.5 by adding excess cook water 365 because it may be undesirable to retain all the starch extracted by the hot water in the step 530 of the method 500. Hereinafter, “partially dewatered” or “partially dewatering” means mechanically separating a portion of the excess cook water 365 from the cooked first mixture 330 that is not needed for hydration of the non-instant rice 310, in accordance with the Step 540 of the method 500. Partial dewatering may be accomplished by placing the first mixture 330 on the water permeable belt 355 such that the excess cook water 365 may drain by gravity feed through the water permeable belt 355, resulting in separation of excess cook water 365, wherein the excess cook water 365 is excess because it is not involved in hydration of the non-instant rice 310. This results in removal of excess starch from the cooked first mixture 330, such that the rice pudding of the present invention has an effective amount of starch needed to act as a stabilizer and to achieve the aforementioned flavor quality attribute.

For example, a non-thixotropic, aseptically processed pudding 610 may be processed from a first mixture 330 that has been cooked in accordance with the step 530 of the method 500, using a ratio of parts by weight of the non-instant rice 310 to parts by weight of the heated water in the first mixture 330 of 0.375. In this example, the non-thixotropic, first mixture 330 having a ratio of rice to water of 0.375 may be prepared from 7.5 parts by weight by weight rice to 20 parts by weight by weight water. The 0.375 ratio of rice to water leaves 5 parts by weight of excess cook water 365, since hydration of the rice requires only 15 of the original 20 parts by weight of the water provided in this example. It has been found that 2 parts by weight of the excess cook water 365 remains with the cooked rice 352, and the remaining 3 parts by weight of excess cook water 365 may be discarded as waste. When a batch of rice is used having higher than typical starch that is extractable by hot water, the excess starch may be discarded with the excess cook 365 water by providing an excess of cook water needed to completely hydrate the rice during cooking in step 540 of the method 500, by adjusting the rice to water ratio between 0.1 and 0.5 parts by weight of rice to parts by weight of water.

FIG. 11 depicts the apparatus 80 of FIG. 8, described above, for forming a rice pudding 103 from the dewatered first mixture 352, in accordance with the step 550 of the method 500 as depicted in FIG. 9B and described herein. The dewatered first mixture 352 should be cooled to less than 150° F. as it emerges from the continuous cooker 370 to avoid over cooking the non instant rice 310. If the rice pudding 103 is made continuously, it is usually subjected to aseptic processing immediately, so it is not subjected to holding at temperatures in the cooking range at which over cooking likely. Hereinafter, “over cooking” the non instant rice 310 means causing the rice to become too soft such that the dewatered first mixture 352 may lose its piece integrity.

In an embodiment, the rice pudding 103 may be made batch-wise by adding the hot dewatered first mixture 352 from feeder 101 through input line 88 and a cooler pudding base 630 from the feeder 610 through feeder line 89 into the batch vessel 87. In this embodiment, the dewatered first mixture 352 may be economically and effectively cooled. Alternatively, the dewatered first mixture 352 may be continuously effectively and economically cooled from a temperature range of about 170° F. to about 212° F. to less than 150° F. as the dewatered first mixture 352 emerges from the continuous cooker 370 by continuously combining the partially dewatered first mixture 352 with a colder pudding base 630 having a temperature less than 150° F., wherein a rate of lowering depends on how much lower a temperature of the pudding base 630 is than a temperature of the dewatered first mixture 352 and how large is a percent by weight of the pudding base 630 in the combined mixture of the pudding base 630 and the dewatered first mixture 352. The pudding base 630 may be at any temperature less than 150° F. Alternatively, the pudding base 630 may be more preferably at a temperature from about 30° F. to about 40° F.

If the rice pudding 103 is made batch-wise, it may be cooled by adding the pudding base 630 by pumping through liquid feed control valve 91 and liquid feed line 89 into the vessel 87, with rapid stirring of the agitator 85 for about 15 minutes. The rice pudding 103 may comprise pudding base 630 from about 80 to about 95 percent by weight and the dewatered first mixture 352 from about 5 to about 20 percent by weight. The aseptic rice pudding 103 may more preferably comprise pudding base 630 from about 90 to about 92 percent by weight and the dewatered first mixture 352 from about 8 to about 10 percent by weight.

In one embodiment, the rice pudding 103 of the step 550 of the method 500 comprises the partially dewatered first mixture 352 in a range from about 5.0 to about 20.0 percent by weight and from about 80 to about 95 percent by weight pudding base 630, more preferably the partially dewatered first mixture 352 in a range from about 8 to about 10 percent by weight and from about 90 to about 92 percent by weight pudding base 630. The pudding base 630 of the step 550 of the method 500 may comprise milk in a range from about 30 to about 77.6 percent by weight of the rice pudding 103 and includes liquid milk, for example, 40% Butter Fat Cream, skim milk and whole milk, and dry milk such as non-fat dry milk. Alternatively, a milk substitute such as sodium caseinate may be used. The rice pudding 103 may further comprise sugar from about 13.5 to about 17.1 percent by weight of the rice pudding and includes liquid sugar, confectioners sugar and any alternative forms of sugar such as granular sugar. Alternatively, sugar substitutes such as saccharine or aspartamene may be used.

In one embodiment, if the rice pudding 103 may be made batch-wise, it may be held in the vessel 87 or may be transferred to a surge tank or other storage vessel that may be part of the aseptic processing system prior to commencing step 560 of the method 500, aseptic processing of the rice pudding. Here it is more important to cool the rice pudding 103 to avoid over cooking which may occur if the rice pudding 103 is held for up to 60 minutes at temperatures greater than 150° F. in the vessel 87 as depicted in FIG. 8, and described herein, or moved to the surge tank or other storage vessel. In one embodiment, the rice pudding 103 was cooled to a temperature range 35° F. to about 45° F. by adding refrigerated pudding base 630 at a temperature from about 30° F. to about 40° F. to the dewatered first mixture in the step 230 of the method 200 is an economical method for reducing the temperature of the mixture 83 from the temperature range from about 190° F. to about 212° F. at which the mixture 83 is maintained during the step 220 of the method 200 to, whereby over cooking in the other storage vessel that may be used to store rice pudding 103 prior to step 240 of the method 200, aseptic processing of the rice pudding, may be minimized or avoided.

In an embodiment in which the rice pudding 103 may have undergone homogenization, such as for example single stage homogenization, the rice pudding 103 may be cooled in the vessel 87, equipped with the agitator 85 of the vessel 87. Alternatively, rice pudding 103 may be cooled by circulating the rice pudding 103 through a tubular and/or scraped surface heat exchanger. Alternatively, the rice pudding 103 may be cooled by passing the rice pudding 103 through a cooling tunnel. In an embodiment of the present invention, circulating the rice pudding 103 through a tubular and/or scraped surface heat exchanger cooled the rice pudding 103 from 45° F. to about 35° F. The rate of stirring should be sufficient to keep the rice in the rice pudding 103 evenly distributed in the vessel 87, such that substantially all the rice in the rice pudding 103 may be transferred when the rice pudding 103 may be aseptically processed in accordance with the step 240 of the method 200, as depicted in FIG. 9, or in accordance with the step 560 of the method 500, as depicted in FIG. 9B and described herein.

FIGS. 6-7 depict a hold tube 40 for aseptic processing, for example, the rice pudding 103, wherein the rice pudding 103 may be may be fed by gravity or pumped to the hold tube 40.

FIG. 7 depicts a longitudinal cross-section of the apparatus 40, wherein, for example, the rice pudding 103, as depicted in FIG. 11, may be passed through the apparatus 40, in a direction of an arrow 25, according to the step 240 of the method 200, as depicted in FIG. 9 and described herein. Referring to FIGS. 4-7, in an embodiment of the present invention, the rice pudding 103 may be heated from about 250° F. to about 280° F. using tubular and/or scrape surface heat exchangers placed in line between the discharge line 97 of the apparatus 80 and the proximal end 24 of the apparatus 40. The apparatus 40 is sized such that the rice pudding 103 may have a residence time of from about 15 to about 30 seconds. The residence time of the rice pudding 103 in the apparatus 40 may be increased by increasing either a length or a diameter of the apparatus 40, without changing the flow rate of the rice pudding 103 through the apparatus 40.

Alternatively the residence time of the rice pudding 103 in the apparatus 40 may be decreased by decreasing the length or the diameter of the apparatus 40, without changing the flow rate of the rice pudding 103 through the apparatus 40. Another method of reducing the residence time in the apparatus 40 may be to increase the flow rate of the rice pudding 103, without changing either a diameter or a length of the apparatus 40. Alternatively, the residence time in the apparatus 40 may be increased by reducing the flow rate of the rice pudding 103 in the apparatus 40, without changing either the diameter or the length of the apparatus 40. Referring to FIG. 7, in order to achieve the residence time of from about 15 to about 30 seconds, one skilled in the art may determine the residence time of the rice pudding 103 in the apparatus 40 by injecting a colored dye that may be detected by the human eye into the proximal end 24 of the apparatus 40 and measuring a difference in time between when the dye was injected to when it appeared at the distal end 28 of the apparatus 40. The difference in time (ΔT) is the residence time of the rice pudding for the flow rate of the rice pudding used during the determination of the residence time ΔT. Alternatively, moisture and temperature sensors could be placed in the rice pudding 103 to obtain a moisture and thermal history of the rice pudding 103.

Referring to FIGS. 6-7, the aseptically processed pudding 610 of the present invention may be cooled as it emerges from the distal end 28 of the apparatus 40. For example, the aseptically processed pudding 610 of the present invention may be cooled from about 280° F. to between about 50° F. and 60° F. by circulating it through a tubular and/or a scraped surface heat exchanger. The cooled aseptically processed pudding 610 may be collected in an aseptic surge tank 600 as it emerges from the tubular and/or a scraped surface heat exchanger. The aseptically processed pudding 610 of the present invention may be aseptically fed to a commercially available ultra-clean sterilized filler for filling final containers with the aseptically processed pudding 610. Hereinafter, “filling” refers to a process of transferring the aseptically processed pudding 610 of the present invention into final containers, using an aseptic ultra-clean sterilized filler. After filling, the aseptically processed pudding 610 may be further cooled from about 50° F. to about 40° F. using a cooling tunnel. Referring to FIGS. 6-11, the following example is provided to further describe the embodiments of the present invention, in particular, examples of methods for aseptically processing rice pudding and examples of the various rice pudding compositions described herein:

### EXAMPLE 2

### All % are Percent by Weight

Referring to FIG. 8 and the step 210 of the method 200 as depicted in FIG. 9, a non-instant rice 110 that includes rice selected from the group of milled rices consisting of long grain rice, medium grain rice, short grain rice, broken grain rice and combinations thereof, is added from bags or other container of the non-instant rice 110 into the vessel 87 by a person emptying the bag or container containing the non-instant rice 110 into a funnel 92 that is operably coupled to an opening 94 into the vessel 87. Referring to FIG. 8 and the step 220 of the method 200 as depicted in FIG. 9, after adding the non-instant rice 110 to the vessel 87, hot water having a temperature of 200° F. is added to the vessel 87 through fluid feed line 89, wherein liquid feed control valve 93 regulates the hot water feed rate, resulting in forming a first mixture 83, such that a ratio of rice to water is 0.37. The hot water is pumped or gravity fed from a heat exchanger capable of heating water to a temperature substantially equal to 200° F. through fluid feed line 89. The first mixture 83 is vigorously agitated by agitator 85, wherein the scrapper blade 82 scrapes the bottom 84 of the vessel 87 is to mix the ingredients in the first mixture 83 during the step 220 so that solids such as for example, the rice, are evenly distributed throughout the first mixture 83 and is maintained at a temperature substantially equal to 200° F., by re-circulating hot water, steam under pressure or hot oil in the jacket 112 for a time substantially equal to 35 minutes. Alternatively, the jacket 112 may be electrically heated. After cooking the mixture 83 for 35 minutes, the mixture 83 is discharged from the vessel 87 into a de-watering conveyor 400 through discharge line 97 at a rate controlled by control valve 108. A weight sensor 462 such as a load cell for determining a weight of the partially de-watered first mixture 452 on the water permeable belt 455 provides a computer or process controller such as the GE Series Six process controller with weight data for regulating the control valve 108, such that a flow of the first mixture 83 through the rice discharge line 97 does not exceed a capacity of the de-watering conveyor 400 for de-watering the rice in the first mixture 83 to provide partially de-watered first mixture 452 from the outlet port 490.

### EXAMPLE 3

### All % are Percent by Weight

Referring to FIG. 10 and the step 510 of the method 500 as depicted in FIG. 9B, hot water pre-heated to 208° F. is added to the apparatus 300 through water feed line 319, wherein a rate of hot water feed is controlled, such that the hot water reaches a level 345 in the continuous cooker 370. The hot water is provided from a heat exchanger and the temperature of the water is maintained in a range of 207 to about 209° F. by providing the jacket 340 with re-circulating hot water, steam under pressure or hot oil in the jacket 340 through heat lines 315 and 316. Alternatively, the jacket 340 may be electrically heated. Referring to FIG. 10 and the step 510 of the method 500 as depicted in FIG. 9B, the first mixture 330 is provided by adding the non-instant rice 310 that includes rice selected from the group of milled rices consisting of long grain rice, medium grain rice, short grain rice, broken grain rice and combinations thereof, into the continuous cooker 370 by a person emptying the bag or container containing the non-instant rice 310 into the addition port 360. Alternatively, the non-instant rice 310 may be added from a solids feeder containing the non-instant rice 310, operatively coupled to the addition port 360, such as may be the solids feeder 90 to the feed line 89 of the apparatus 80 as depicted in FIG. 8 and described herein. A ratio of rice to water is maintained from about 0.1 to 0.5, such that the ratio provides excess cook water 365 for removing excess starch on the dewatered cooked rice 352 to provide an effective amount of starch in the aseptically processed pudding 610 of the present invention. The auger 320 rotates at a rate of 1 revolution in a time substantially equal to 2.45 minutes, resulting in a residence time of the first mixture 330 in the continuous cooker 370 substantially equal to 27 minutes, in accordance with the method 530 of the method 500. The water in the first mixture 330 is moved by the auger 320 along with the rice to avoid damaging the rice such as distorting the shape, breaking or mashing the rice in the first mixture 330 during displacement by the helical auger 320. The first mixture 330 is discharged from the continuous cooker 370 into a de-watering conveyor 353 through discharge line 395 and partially dewatered, in accordance with the step 540 of the method 500. A weight sensor 362 such as a load cell for determining a weight of the de-watered rice 352 on the water permeable belt 355 provides a computer or process controller such as the GE Series Six process controller with weight data for regulating a rate of discharge of the first mixture 330 from the discharge port 349, such that a flow of the first mixture 330 through the rice discharge line 395 does not exceed a capacity of the de-watering conveyor 353 for de-watering the rice in the first mixture 330 to provide de-watered rice 352 from the outlet port 390, such that the aseptically processed pudding 610 made from the dewatered rice 352 has an effective amount of starch. Alternatively, if the flow of the first mixture 330 through the rice discharge line 395 does exceed the capacity of the de-watering conveyor 353, the flow of the first mixture 330 is diverted to a surge tank.

### EXAMPLE 4

### All % are Percent by Weight

Referring to FIG. 11, and the step 230 of the method 200 as depicted in FIG. 9, or the step 550 of the step 500 the rice pudding 103 is formed in vessel 87, equipped with the agitator 85 and scrapping blade 82, by adding the following to the vessel 87 and after completion of the addition, mixing for fifteen (15) minutes using the agitator 85 of the vessel 87: the rice pudding 103 may be formed by combining from about 25.0 percent to about 45.0 percent by weight of the partially de-watered rice 352 of Examples 2 and 3 with a balance of the total rice pudding 103 being pudding base 630, said pudding base 103 comprising: liquid milk, 30-40%; sugar 9-20%; heavy cream 1.00-10.00%; egg yolk 0.10-1.00%; non fat dry milk 0.30-5.0%.

The pudding base 630 was homogenized at 1500 psi single stage, and the homogenate was cooled to about 40° F. and collected in a vessel, equipped with an agitator. FIG. 11 depicts FIG. 8 after forming the rice pudding 103 from the first mixture 83, in accordance with the step 230 of the method 200, as depicted in FIG. 9 and described herein. Alternatively the rice pudding 103 may be formed by combining the dewatered first mixture 352 and a pudding base 630, wherein an effective amount of starch remains in the rice pudding 103 after partially dewatering the first mixture 330, in accordance with the Step 550 of the method 500, as depicted in FIG. 9B and described herein. Referring to FIGS. 8-11 and the step 230 of the method 200 as depicted in FIG. 9, the de-watered rice 352 from the apparatus 80, or the de-watered rice 352 from the rice cooker 300 was added to the pudding base 630 in the apparatus 80, with mixing for about 15 minutes using the agitator 85 to form the rice pudding 103. The rice pudding 103 was pre-heated by circulating the mixture 53 through tubular and/or scrape surface heat exchangers from 40° F. to 250° F. Alternatively, the rice pudding 103 may be heated by the apparatus 80 if the apparatus tank 80 is equipped with a heated jacket.

Referring to FIGS. 6-7, according to the step 38 of the method 10 as depicted in FIG. 1, and the step 240 of the method 200 as depicted in FIG. 9, and the step 560 of the method 500, the aseptically produced rice pudding of the present invention is produced by aseptically processing the rice pudding 103 by passing the rice pudding 103 through the holding tube 40, wherein the apparatus tube 22 is heated by a scrape and/or surface heat exchanger to about 280_F., wherein the residence time of the rice pudding 103 in the apparatus 40 is 25 seconds. Referring to FIG. 7, the aseptically processed pudding 610 of the present invention may be cooled from about 280° F. to between about 50° F. and 60° F. by circulating the aseptically processed pudding 610 through a tubular and/or scraped surface heat exchanger. The aseptically processed pudding 610 of the present invention may be collected in an aseptic surge tank 600 as it emerges from the distal end 28 of the tube 40. The aseptically processed rice pudding 610 of the present invention may be aseptically fed to a commercially available ultra-clean sterilized filler for filling final containers with the aseptically processed pudding 610. After filling, the aseptically processed rice pudding 610 may be further cooled from about 50° F. to about 40° F. using a cooling tunnel.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for processing rice pudding, comprising:
cooking a first mixture, wherein the first mixture includes non-instant rice and water;
partially dewatering the first mixture, wherein excess starch is removed from the partially dewatered first mixture;
forming a rice pudding that includes the partially dewatered first mixture and a pudding base, wherein the rice pudding has an effective amount of starch; and
aseptically processing the rice pudding.

2. The method of claim 1, wherein the non instant rice is cooked at a temperature from about 190° F. to about 212° F. for from about 20 min. to about 35 min.

3. The method of claim 1, wherein the non instant rice is cooked at a temperature from about 170° F. to about 212° F. for from about 10 min. to about 50 min.

4. The method of claim 1, wherein the rice in the first mixture includes a long grain rice.

5. The method of claim 1, wherein the pudding base comprises an additive selected from the group consisting of a liquid milk, a sugar and combinations thereof.

6. The method of claim 1, wherein the pudding base comprises salt, egg yolk, phosphate, a flavoring agent, a coloring agent and combinations thereof.

7. The method of claim 6, wherein the phosphate is tetra sodium pyrophosphate.

8. The method of claim 1, further comprising homogenizing the base before adding the pudding base to the mixture.

9. The method of claim 6, wherein the pudding base is selected from the group consisting of liquid milk, sugar, cream, non-fat dry milk, egg yolk, salt, phosphate, flavoring agent, coloring agent and combinations thereof.

10. The method of claim 1, wherein aseptically processing the rice pudding includes heating the rice pudding according to an ultra-high-temperature (UHT) method.

11. The method of claim 1, wherein prior to aseptically processing the rice pudding the pudding base is cooled to below 50° F., wherein the dewatered first mixture is added to the cooled pudding base to cool the dewatered first mixture.

12. The method of claim 1, wherein prior to aseptically processing the rice pudding the pudding base is cooled to between 30° F. and 40° F., wherein the dewatered first mixture is added to the cooled pudding base to cool the dewatered first mixture.

13. The method of claim 1, wherein the aseptically processed mixture has acceptable quality attributes.

14. The method of claim 1, wherein aseptically processing the rice pudding results in the rice having piece integrity.

15. The method of claim 1, wherein the non-instant rice has been exposed to water to soften the non instant rice before cooking.

16. A method for processing rice pudding, comprising:
adding a first mixture to a continuous rice cooker, wherein the first mixture includes non-instant rice and heated water;
continuously cooking the first mixture in the cooker;
partially dewatering the first mixture after cooking;
forming a rice pudding by combining the dewatered first mixture and a pudding base, wherein an effective amount of starch remains in the rice pudding after partially dewatering the first mixture; and
aseptically processing the rice pudding.

17. The method of claim 16, wherein the continuous cooker includes a helical auger that rotates on a longitudinal axis of the vessel.

18. The method of claim 17, wherein a cook time of the rice is inversely proportional to a rotation rate of the auger.

19. The method of claim 16, wherein the non instant rice is cooked at a temperature from about 190° F. to about 212° F. for from about 20 min. to about 35 min.

20. The method of claim 16, wherein the pudding base is selected from the group consisting of liquid milk, sugar, cream, non-fat dry milk, egg yolk, salt, phosphate, flavoring agent, coloring agent and combinations thereof.

21. The method of claim 16, wherein aseptically processing the rice pudding includes heating the rice pudding according to an ultra-high-temperature (UHT) method.

22. The method of claim 16, wherein the non instant rice is cooked for from about 25 minutes to about 29 minutes at a temperature from about 205° F. to about 209° F.

23. The method of claim 16, wherein the non-instant rice has been exposed to water to soften the non instant rice before cooking.

24. An aseptic rice pudding comprising: an aseptic mixture that includes from about 30.0 to about 40.0 percent by weight milk, from about 9.0 to about 20.0 percent by weight sugar, and from about 25.0 to about 45.0 percent by weight of dewatered rice.

25. The rice pudding of claim 20, wherein the rice is long grain rice.

26. A method for processing rice pudding, comprising:
continuously cooking a first mixture which includes non-instant rice and water;
combining the first mixture with a pudding base to form a rice pudding; and
aseptically processing the rice pudding.

27. The method of claim 26, wherein the rice is selected from the group consisting of milled long grain, milled medium grain, milled broken grain and combinations thereof.

28. The method of claim 26, wherein the non-instant rice is cooked from 190° F. to about 212° F. for from about 20 min. to about 35 min.

29. The method of claim 26, wherein the rice pudding comprises a milk, a sugar, and combinations thereof.

30. The method of claim 26, wherein the rice pudding includes an additive selected from the group consisting of a salt, a sugared egg yolk, tetra sodium pyrophosphate, a flavoring agent, a coloring agent and combinations thereof.

31. The method of claim 26, further comprising homogenizing the pudding base before adding the pudding base to the rice pudding.

32. The method of claim 24, wherein the pudding base is selected from the group consisting of liquid milk, sugar, cream, non-fat dry milk, egg yolk, salt, phosphate, flavoring agent, coloring agent and combinations thereof.

33. The method of claim 26, wherein aseptically processing the rice pudding includes heating the rice pudding according to an ultra-high-temperature (UHT) method.

34. The method of claim 26, wherein prior to aseptically processing the rice pudding the pudding base is cooled to below 50° F., wherein the dewatered first mixture is added to the cooled pudding base to cool the dewatered first mixture.

35. The method of claim 26, wherein prior to aseptically processing the rice pudding the pudding base is cooled to between 30° F. and 40° F., wherein the dewatered first mixture is added to the cooled pudding base to cool the dewatered first mixture.

36. The method of claim 26, wherein the aseptically processed mixture has acceptable quality attributes.

37. The method of claim 26, wherein the non-instant rice has been exposed to water to soften the non instant rice before cooking.

38. A method for processing rice pudding, comprising:
forming a first mixture, wherein the first mixture includes non-instant rice and heated water, wherein the heated water extracts starch from the rice, and wherein an effective amount of the extracted starch remains in the first mixture;
combining the first mixture and a pudding base to form a rice pudding: and
aseptically processing the rice pudding.

39. A method for processing rice pudding, comprising:
forming a first mixture, wherein the first mixture includes non-instant rice and heated water, wherein the heated water extracts starch from the rice, and wherein an effective amount of the extracted starch remains in the first mixture;
combining the first mixture and a pudding base to form a rice pudding:
cooling the rice pudding by adding the first mixture to the pudding base, wherein the pudding base is less than 50° F.; and
aseptically processing the rice pudding.
